(19) United States
(12) Patent Application Publication
(10) Pub. No.: US 2020/0381133 A1
(43) Pub. Date: Dec. 3, 2020

(54) METHODS OF PREPARING MATRIX FOR VITRIFICATION OF RADIOACTIVE WASTE AND GLASS WASTEFORM

(71) Applicant: Southwest University of Science and Technology, Mianyang (CN)

(72) Inventors: Jichuan HUO, Mianyang (CN); Yonglin HUO, Mianyang (CN); Xingquan ZHANG, Mianyang (CN); Xiang JI, Mianyang (CN); Qihui LIAN, Mianyang (CN)

(21) Appl. No.: 16/854,817

(22) Filed: Apr. 21, 2020

(30) Foreign Application Priority Data
May 27, 2019 (CN) 201910446646.5

(51) Int. Cl. G21F 9/30; C03B 5/00

(52) U.S. Cl. CPC G21F 9/305; C03B 5/005

(57) ABSTRACT

Disclosed herein is a method for preparing a matrix for vitrifying radioactive waste, including: grinding natural magmatic rocks; and melting the ground product at 1450-1500° C. for 3-4.5 h followed by moulding and annealing to produce the matrix. The matrix includes 45%-65% by weight of SiO₂, 9%-18% by weight of Al₂O₃, 4%-12% by weight of CaO, 3%-10% by weight of MgO, 6%-16% by weight of Fe₂O₃+FeO, 2%-9% by weight of Na₂O+K₂O and 1%-5% by weight of TiO₂. The matrix is doped with simulated radioactive waste, ground, melted, moulded and annealed to obtain a glass wasteform with good chemical and thermal stability.

### CROSS-REFERENCE TO RELATED APPLICATIONS

This application claims the benefit of priority from Chinese Patent Application No. 201910446646.5, filed on May 27, 2019. The content of the aforementioned application, including any intervening amendments thereto, is incorporated herein by reference in its entirety.

### TECHNICAL FIELD

The present application relates to disposal of radioactive waste, and more particularly to methods of preparing a matrix for vitrification of radioactive waste and glass wasteform (i.e., glass wasteform containing radioactive waste or simulated radioactive waste), which are suitable for the solidification of radioactive waste discharged in nuclear industry, etc.

### BACKGROUND OF THE INVENTION

The use of nuclear energy will generate large amounts of radioactive waste which contains a considerable number of actinides and fissionable elements with a long half-life, high toxicity and strong radioactivity.

In the prior art, the radioactive waste is treated mainly by glass solidification, ceramic solidification and glass-ceramic solidification, where the glass solidification involves good adjustability in composition, simple processes and convenient remote operation, as well as the ability to solidify all components of radioactive waste by one step. Moreover, the glass solidification is mature in the current engineering technology and has been practically applied in France, the United States, Britain, Russia, etc. In the solidification of radioactive waste, borosilicate and phosphate glass systems are preferred around the world due to good corrosion resistance and stable chemical properties.

In the prior art, the glass wasteform is predominated by glass phase and displays poor waste loading capacity and unsatisfactory mid-and-long term safety (400-500 years to over 10,000 years). With regard to the ceramic solidification, this technique is based on natural analogy to choose a stable naturally-occurring mineral to achieve the lattice solid solution of the nuclide. However, the ceramic solidification has complicated processes and high selectivity to elements in radioactive waste, so that it fails to solidify all components in the radioactive waste by one step and still remains to be improved for practical use. But such mineral is considered to be a relatively ideal matrix for the single solidification of (secondary) actinide nuclides in the radioactive waste.

In the prior art, there are no reports on the use of the magmatic rocks in the preparations of a matrix for the vitrification of the radioactive waste and a glass wasteform.

### SUMMARY OF THE INVENTION

In order to overcome the defects in the prior art, this invention provides methods of preparing a matrix for vitrifying radioactive waste and a glass wasteform. Based on the matrix provided herein, a novel method with good properties for preparing a glass wasteform containing (simulated) radioactive waste is developed to achieve the solidification of radioactive waste.

Technical solutions of the invention are described as follows.

In one aspect, this invention provides a method for preparing a matrix for vitrification of radioactive waste, comprising:

(1) grinding a natural magmatic rock;

(2) melting the ground natural magmatic rock at 1450-1500° C. for 3-4.5 h;

(3) moulding the melted product in a mold preheated to 700-850° C.; and

(4) keeping the moulded product at 600-700° C. for 1-2 h followed by cooling to room temperature at a rate of 1-2° C./min to prepare the matrix for the vitrification of the radioactive waste.

The matrix obtained in step (4) comprises 45%-65% by weight of SiO₂, 9%-18% by weight of Al₂O₃, 4%-12% by weight of CaO, 3%-10% by weight of MgO, 6%-16% by weight of Fe₂O₃+FeO, 2%-9% by weight of Na₂O+K₂O and 1%-5% by weight of TiO₂, where the matrix further comprises 1%-5% by weight of at least five compounds selected from the group consisting of MnO, P₂O₅, SO₃, BaO, SrO, ZrO₂, CuO, ZnO, Nb₂O₅, Rb₂O and Y₂O₃.

The matrix obtained in step (4) comprises 49.70% by weight of SiO₂, 14.83% by weight of Al₂O₃, 8.76% by weight of CaO, 4.27% by weight of MgO, 10.52% by weight of Fe₂O₃+FeO, 4.78% by weight of Na₂O, 1.99% by weight of K₂O and 3.16% by weight of TiO₂, where the matrix further comprises 1.99% by weight of at least five compounds selected from the group consisting of MnO, P₂O₅, SO₃, BaO, SrO, ZrO₂, CuO, ZnO, Nb₂O₅, Rb₂O and Y₂O₃.

The matrix obtained in step (4) comprises 47.73% by weight of SiO₂, 14.22% by weight of Al₂O₃, 9.29% by weight of CaO, 4.81% by weight of MgO, 13.01% by weight of Fe₂O₃+FeO, 2.19% by weight of Na₂O, 1.48% by weight of K₂O and 3.37% by weight of TiO₂, where the matrix further comprises 3.90% by weight of at least five compounds selected from the group consisting of MnO, P₂O₅, SO₃, BaO, SrO, ZrO₂, CuO, ZnO, Nb₂O₅, Rb₂O and Y₂O₃.

In another aspect, the invention provides a method for preparing a glass wasteform of radioactive waste, comprising:

(1) grinding and mixing 93%-99% by weight of the matrix mentioned above with 1%-7% by weight of simulated radioactive waste to produce a mixture;

wherein the simulated radioactive waste is MoO₃ or Nd₂O₃, and the grinding is performed by a ball mill, and the mixture has a particle size less than 200 mesh;

(2) melting the mixture at 1100-1300° C. for 3-4.5 h;

(3) moulding the melted product in a mold preheated to 700-850° C.; and

(4) keeping the moulded product at 600-700° C. for 1-2 h followed by cooling to room temperature at a rate of 1-2° C./min to prepare the glass wasteform of radioactive waste (that is the glass wasteform of the simulated radioactive waste).

The grinding in step (1) is crushing by a jaw crusher and then milling by a ball mill, and the ground product has a particle size less than 200 mesh.

In step (1), 95%-99% by weight of the matrix prepared by the above method and 1%-5% by weight of the simulated radioactive waste are mixed; and the simulated radioactive waste is MoO₃.

In step (1), the matrix comprises 45%-65% by weight of SiO₂, 9%-18% by weight of Al₂O₃, 4%-12% by weight of CaO, 3%-10% by weight of MgO, 6%-16% by weight of Fe₂O₃+FeO, 2%-9% by weight of Na₂O+K₂O and 1%-5% by weight of TiO₂, where the matrix further comprises 1%-5% by weight of at least five compounds selected from the group consisting of MnO, P₂O₅, SO₃, BaO, SrO, ZrO₂, CuO, ZnO, Nb₂O₅, Rb₂O and Y₂O₃.

In step (1), the matrix comprises 49.70% by weight of SiO₂, 14.83% by weight of Al₂O₃, 8.76% by weight of CaO, 4.27% by weight of MgO, 10.52% by weight of Fe₂O₃+FeO, 4.78% by weight of Na₂O, 1.99% by weight of K₂O and 3.16% by weight of TiO₂, where the matrix further comprises 1.99% by weight of at least five compounds selected from the group consisting of MnO, P₂O₅, SO₃, BaO, SrO, ZrO₂, CuO, ZnO, Nb₂O₅, Rb₂O and Y₂O₃.

In step (1), the matrix comprises 47.73% by weight of SiO₂, 14.22% by weight of Al₂O₃, 9.29% by weight of CaO, 4.81% by weight of MgO, 13.01% by weight of Fe₂O₃+FeO, 2.19% by weight of Na₂O, 1.48% by weight of K₂O and 3.37% by weight of TiO₂, where the matrix further comprises 3.90% by weight of at least five compounds selected from the group consisting of MnO, P₂O₅, SO₃, BaO, SrO, ZrO₂, CuO, ZnO, Nb₂O₅, Rb₂O and Y₂O₃.

Compared to the prior art, this invention has the following features and beneficial effects.

(1) Natural magmatic rocks, also known as igneous rocks, are employed herein, which are formed through the cooling and solidification of magma erupting onto earth surfaces or penetrating into the crust, and are a main component in the crust. Common magmatic rocks include granite, granite porphyry, rhyolite, orthoclase, diorite, andesite, gabbro and basalt. Magmatic rocks have existed in nature for more than billions of years due to their stable chemical and physical properties as well as strong weatherability. Magmatic rocks have a wide range of applications, for example, they are applied as a preferred material in the constructions of highways, railways and airport runways. Due to the advantages of low crushing value, strong resistance to pressure, corrosion and wear and low water adsorption, the magmatic rocks are well recognized as a basic material for the development of railway and highway transport. Magmatic rocks are also a favored raw material in the production of “cast stone”, and can be subjected to melting, casting, crystallization and annealing to produce a novel material which is comparable to alloy steel in hardness and wear resistance and better than the lead and rubber in corrosion resistance. The glass wasteform of the radioactive waste is widely accepted as one of solidified materials that can be safely disposed. Radioactive waste and matrices are melted at high temperature to form the uniform and stable glass wasteform which satisfies various disposal indexes. The irregular network structure of the glass can stably trap radionuclides, and the molten glass at a high temperature can dissolve various types of oxides. Theoretically, glass has an excellent trapping capacity of oxides in waste. The radioactive waste vitrification has been engineered in developed countries, whereas this technique in China is still under research. Natural magmatic rocks are formed as a result of natural high temperature melting and have good performance in forming glass network structure. Once melted again by high-temperature heating, the natural magmatic rocks will be prone to forming a stable glass form. Therefore, natural magmatic rocks are selected as a matrix in the preparation of a glass wasteform of radioactive waste.

(2) Nd₂O₃ and MoO₃ are used in the invention to respectively simulate Nd and Mo in the radioactive waste, and Nd is used in the invention to simulate actinide nuclides. It can be seen from the glass structure theory that though Nd₂O₃ and MoO₃ fail to enter the network structure in silicate glass, they can form a stable glass form to a certain extent.

(3) This invention indirectly improves the mid-and-long term (400-500 years to over 10,000 years) safety of the glass wasteform of radioactive waste. There are a small number of radioactive elements (such as uranium and plutonium) naturally existing in natural magmatic rocks, and these natural magmatic rocks have been confirmed to stably exist for billions of years. Inspired by this, it can be speculated that the glass wasteform of radioactive waste prepared from the natural magmatic rocks involves good safety in the medium to long term.

(4) The invention uses the matrix to vitrify the radioactive waste, and the resulting glass wasteform of the radioactive waste (or the simulated radioactive waste) has good chemical and thermal stability, obvious solidification effect and small weight loss rate of elements.

(5) The invention involves inexpensive and readily available raw materials, simple process, easy operation, desirable controllability and high practicality, and it is prone to engineering.

### DETAILED DESCRIPTION OF EMBODIMENTS

The embodiments below are intended to further describe this invention, but are not intended to limit the scope of the invention. Any modifications and adjustments made by those skilled in the art based on the disclosure of the invention shall fall within the scope of the invention.

### EXAMPLE 1

A method for preparing a matrix for vitrifying radioactive waste was provided herein, which was specifically described as follows.

(1) Grinding

Natural magmatic rocks were used as raw materials and ground (specifically crushed by a jaw crusher and milled by a ball mill).

(2) Melting

The ground product was heated and melted at 1480° C. for 3.5 h.

(3) Moulding

The melted product was moulded in a mold preheated to 800° C.

(4) Annealing

The moulded product was kept at 600° C. for 1 h and cooled to room temperature at a rate of 1° C./min to produce the matrix for vitrifying radioactive waste.

The matrix obtained in step (4) included 49.70% by weight of SiO₂, 14.83% by weight of Al₂O₃, 8.76% by weight of CaO, 4.27% by weight of MgO, 10.52% by weight of Fe₂O₃+FeO, 4.78% by weight of Na₂O, 1.99% by weight of K₂O and 3.16% by weight of TiO₂, where the matrix further included 1.99% by weight of at least five compounds selected from the group consisting of MnO, P₂O₅, SO₃, BaO, SrO, ZrO₂, CuO, ZnO, Nb₂O₅, Rb₂O and Y₂O₃.

### EXAMPLE 2

A method for preparing a matrix for vitrifying radioactive waste was provided herein, which was specifically described as follows.

(1) Grinding

Natural magmatic rocks were used as raw materials and ground (specifically crushed by a jaw crusher and milled by a ball mill).

(2) Melting

The ground product was heated and melted at 1450° C. for 3-3.5 h.

(3) Moulding

The melted product was moulded in a mold preheated to 800° C.

(4) Annealing

The moulded product was kept at 600° C. for 1 h and cooled to room temperature at a rate of 1° C./min to produce the matrix for vitrifying radioactive waste.

The matrix obtained in step (4) included 47.73% by weight of SiO₂, 14.22% by weight of Al₂O₃, 9.29% by weight of CaO, 4.81% by weight of MgO, 13.01% by weight of Fe₂O₃+FeO, 2.19% by weight of Na₂O, 1.48% by weight of K₂O and 3.37% by weight of TiO₂, where the matrix further included 3.90% by weight of at least five compounds selected from the group consisting of MnO, P₂O₅, SO₃, BaO, SrO, ZrO₂, CuO, ZnO, Nb₂O₅, Rb₂O and Y₂O₃.

### EXAMPLE 3

A method for preparing a glass wasteform of radioactive waste was provided herein, which was specifically described as follows.

(1) Grinding and Mixing

28.5 g of the matrix of Example 1 and 1.5 g of MoO₃ as simulated radioactive waste were ground and mixed to produce a mixture, where the matrix used herein included 49.70% by weight of SiO₂, 14.83% by weight of Al₂O₃, 8.76% by weight of CaO, 4.27% by weight of MgO, 10.52% by weight of Fe₂O₃+FeO, 4.78% by weight of Na₂O, 1.99% by weight of K₂O and 3.16% by weight of TiO₂, where the matrix further included 1.99% by weight of at least five compounds selected from the group consisting of MnO, P₂O₅, SO₃, BaO, SrO, ZrO₂, CuO, ZnO, Nb₂O₅, Rb₂O and Y₂O₃, and the grinding was performed by a ball mill, and the mixture had a particle size less than 200 mesh.

(2) Melting

The mixture was heated and melted at 1250° C. for 3 h.

(3) Moulding

The melted product was moulded in a mold preheated to 800° C.

(4) Annealing

The moulded product was kept at 600° C. for 1 h and cooled to room temperature at a rate of 1° C./min to produce the glass wasteform of MoO₃ radioactive waste.

The glass wasteform of MoO₃ radioactive waste prepared herein was immersed in deionized water at 90° C. for 28 days, where the weight loss rate of element Mo was less than 2×10⁻⁵ g·m⁻²·d⁻¹.

### EXAMPLE 4

A method for preparing a glass wasteform of radioactive waste was provided herein, which was specifically described as follows.

(1) Grinding and Mixing

28.5 g of the matrix of Example 2 and 1.5 g of Nd₂O₃ as simulated radioactive waste were ground and mixed to produce a mixture, where the matrix used herein included 47.73% by weight of SiO₂, 14.22% by weight of Al₂O₃, 9.29% by weight of CaO, 4.81% by weight of MgO, 13.01% by weight of Fe₂O₃+FeO, 2.19% by weight of Na₂O, 1.48% by weight of K₂O and 3.37% by weight of TiO₂, where the matrix further included 3.90% by weight of at least five compounds selected from the group consisting of MnO, P₂O₅, SO₃, BaO, SrO, ZrO₂, CuO, ZnO, Nb₂O₅, Rb₂O and Y₂O₃, and the grinding was performed by a ball mill, and the mixture had a particle size less than 200 mesh.

(2) Melting

The mixture was heated and melted at 1200° C. for 3 h.

(3) Moulding

The melted product was moulded in a mold preheated to 800° C.; and

(4) Annealing

The moulded product was kept at 600° C. for 1 h and cooled to room temperature at a rate of 1° C./min to produce the glass wasteform of Nd₂O₃ radioactive waste.

The glass wasteform of Nd₂O₃ radioactive waste prepared herein was immersed in deionized water at 90° C. for 28 days, where the weight loss rate of element Nd was less than 5×10⁻⁶ g·m⁻²·d⁻¹.

### EXAMPLE 5

A method for preparing a matrix for vitrifying radioactive waste was provided herein, which was specifically described as follows.

(1) Grinding

Natural magmatic rocks were used as raw materials and ground.

(2) Melting

The ground product was heated and melted at 1480° C. for 4 h.

(3) Moulding

The melted product was moulded in a mold preheated to 780° C.

(4) Annealing

The moulded product was kept at 650° C. for 1.5 h and cooled to room temperature at a rate of 1.5° C./min to produce the matrix for vitrifying radioactive waste.

The matrix obtained in step (4) included 51.89% by weight of SiO₂, 13.56% by weight of Al₂O₃, 7.78% by weight of CaO, 6.54% by weight of MgO, 10.78% by weight of Fe₂O₃+FeO, 4.89% by weight of Na₂O+K₂O and 2.28% by weight of TiO₂, where the matrix further included 2.28% by weight of at least five compounds selected from the group consisting of MnO, P₂O₅, SO₃, BaO, SrO, ZrO₂, CuO, ZnO, Nb₂O₅, Rb₂O and Y₂O₃.

### EXAMPLE 6

A method for preparing a matrix for vitrifying radioactive waste was provided herein, which was specifically described as follows.

(1) Grinding

Natural magmatic rocks were used as raw materials and ground.

(2) Melting

The ground product was heated and melted at 1450° C. for 4.5 h.

(3) Moulding

The melted product was moulded in a mold preheated to 700° C.

(4) Annealing

The moulded product was kept at 600° C. for 2 h and cooled to room temperature at a rate of 1° C./min to produce the matrix for vitrifying radioactive waste.

The matrix obtained in step (4) included 49.23% by weight of SiO₂, 16.21% by weight of Al₂O₃, 7.56% by weight of CaO, 6.54% by weight of MgO, 10.32% by weight of Fe₂O₃+FeO, 4.25% by weight of Na₂O+K₂O and 1.89% by weight of TiO₂, where the matrix further included 4.09% by weight of at least five compounds selected from the group consisting of MnO, P₂O₅, SO₃, BaO, SrO, ZrO₂, CuO, ZnO, Nb₂O₅, Rb₂O and Y₂O₃.

### EXAMPLE 7

A method for preparing a matrix for vitrifying radioactive waste was provided herein, which was specifically described as follows

(1) Grinding

Natural magmatic rocks were used as raw materials and ground.

(2) Melting

The ground product was heated and melted at 1500° C. for 3 h.

(3) Moulding

The melted product was moulded in a mold preheated to 850° C.

(4) Annealing

The moulded product was kept at 700° C. for 1 h and cooled to room temperature at a rate of 2° C./min to produce the matrix for vitrifying radioactive waste.

The matrix obtained in step (4) included 45.52% by weight of SiO₂, 14.12% by weight of Al₂O₃, 9.31% by weight of CaO, 7.28% by weight of MgO, 11.56% by weight of Fe₂O₃+FeO, 5.51% by weight of Na₂O+K₂O and 2.12% by weight of TiO₂, where the matrix further included 4.58% by weight of at least five compounds selected from the group consisting of MnO, P₂O₅, SO₃, BaO, SrO, ZrO₂, CuO, ZnO, Nb₂O₅, Rb₂O and Y₂O₃.

### EXAMPLES 8-14

A method for preparing a matrix for vitrifying radioactive waste was provided herein, which was specifically described as follows.

(1) Grinding

Natural magmatic rocks were used as raw materials and ground.

(2) Melting

The ground product was heated and melted at 1450-1500° C. for 3-4.5 h.

(3) Moulding

The melted product was moulded in a mold preheated to 700-850° C.

(4) Annealing

The moulded product was kept at 600-700° C. for 1-2 h and cooled to room temperature at a rate of 1-2° C./min to produce the matrix for vitrifying radioactive waste.

The matrix obtained in step (4) included 45%-65% by weight of SiO₂, 9%-18% by weight of Al₂O₃, 4%-12% by weight of CaO, 3%-10% by weight of MgO, 6%-16% by weight of Fe₂O₃+FeO, 2%-9% by weight of Na₂O+K₂O and 1%-5% by weight of TiO₂, where the matrix further included 1%-5% by weight of at least five compounds selected from the group consisting of MnO, P₂O₅, SO₃, BaO, SrO, ZrO₂, CuO, ZnO, Nb₂O₅, Rb₂O and Y₂O₃. The compositions of matrices prepared in Examples 8-14 were shown in Table 1.

TABLE 1
Compositions of the matrices of Examples 8-14

| | Exam- | Exam- | Exam- | Exam- | Exam- | Exam- | Exam- |
|---|---|---|---|---|---|---|---|
| | ple 8 | ple 9 | ple 10 | ple 11 | ple 12 | ple 13 | ple 14 |
| Compo- | (wt. | (wt. | (wt. | (wt. | (wt. | (wt. | (wt. |
| sitions | %) | %) | %) | %) | %) | %) | %) |
| SiO₂ | 45.32 | 47.19 | 50.80 | 52.73 | 55.95 | 58.32 | 62.07 |
| Al₂O₃ | 13.55 | 14.22 | 14.40 | 13.15 | 12.30 | 17.24 | 15.50 |
| CaO | 9.35 | 9.19 | 7.92 | 8.61 | 6.54 | 4.56 | 5.41 |
| MgO | 4.33 | 4.45 | 4.47 | 6.37 | 3.50 | 3.59 | 3.13 |
| Fe₂O₃ + | 15.65 | 13.91 | 9.81 | 9.46 | 9.04 | 9.58 | 6.92 |
| FeO | | | | | | | |
| Na₂O + | 3.61 | 4.63 | 7.55 | 4.29 | 8.26 | 2.99 | 4.25 |
| K₂O | | | | | | | |
| TiO₂ | 4.02 | 2.95 | 2.16 | 1.41 | 1.02 | 2.06 | 1.04 |
| Other | 4.17 | 3.46 | 2.89 | 3.98 | 3.39 | 1.66 | 1.05 |
| com- | | | | | | | |
| ponents | | | | | | | |

### EXAMPLE 15

A matrix for vitrifying radioactive waste was prepared herein according to the process in any one of Examples 5-14, where the matrix included 49.70% by weight of SiO₂, 14.83% by weight of Al₂O₃, 8.76% by weight of CaO, 4.27% by weight of MgO, 10.52% by weight of Fe₂O₃+FeO, 4.78% by weight of Na₂O, 1.99% by weight of K₂O and 3.16% by weight of TiO₂, where the matrix further included 1.99% by weight of at least five compounds selected from the group consisting of MnO, P₂O₅, SO₃, BaO, SrO, ZrO₂, CuO, ZnO, Nb₂O₅, Rb₂O and Y₂O₃.

### EXAMPLE 16

A matrix for vitrifying radioactive waste was prepared herein according to the process in any one of Examples 5-14, where the matrix included 47.73% by weight of SiO₂, 14.22% by weight of Al₂O₃, 9.29% by weight of CaO, 4.81% by weight of MgO, 13.01% by weight of Fe₂O₃+FeO, 2.19% by weight of Na₂O, 1.48% by weight of K₂O and 3.37% by weight of TiO₂, where the matrix further included 3.90% by weight of at least five compounds selected from the group consisting of MnO, P₂O₅, SO₃, BaO, SrO, ZrO₂, CuO, ZnO, Nb₂O₅, Rb₂O and Y₂O₃.

### EXAMPLE 17

A method for preparing a glass wasteform of radioactive waste was provided herein, which was specifically described as follows.

(1) Grinding and Mixing

93% by weight of the matrix mentioned above and 7% by weight of simulated radioactive waste were ground and mixed to produce a mixture, where the simulated radioactive waste was MoO₃ or Nd₂O₃, and the grinding was performed by a ball mill, and the mixture had a particle size less than 200 mesh.

(2) Melting

The mixture was heated and melted at 1100° C. for 4.5 h.

(3) Moulding

The melted product was moulded in a mold preheated to 700° C.

(4) Annealing

The moulded product was kept at 600° C. for 2 h and cooled to room temperature at a rate of 1° C./min to produce the glass wasteform of the radioactive waste (i.e., the glass wasteform of the simulated radioactive waste).

### EXAMPLE 18

A method for preparing a glass wasteform of radioactive waste was provided herein, which was specifically described as follows.

(1) Grinding and Mixing

99% by weight of the matrix prepared by the above method and 1% by weight of simulated radioactive waste were ground and mixed to produce a mixture, where the simulated radioactive waste was MoO₃ or Nd₂O₃, and the grinding was performed by a ball mill, and the mixture had a particle size less than 200 mesh.

(2) Melting

The mixture was heated and melted at 1300° C. for 3 h.

(3) Moulding

The melted product was moulded in a mold preheated to 850° C.

(4) Annealing

The moulded product was kept at 700° C. for 1 h and cooled to room temperature at a rate of 2° C./min to produce the glass wasteform of the radioactive waste (i.e., the glass wasteform of the simulated radioactive waste).

### EXAMPLE 19

A method for preparing a glass wasteform of radioactive waste was provided herein, which was specifically described as follows.

(1) Grinding and Mixing

96% by weight of the matrix prepared by the above method and 4% by weight of simulated radioactive waste were ground and mixed to produce a mixture, where the simulated radioactive waste was MoO₃ or Nd₂O₃, and the grinding was performed by a ball mill, and the mixture had a particle size less than 200 mesh.

(2) Melting

The ground product was heated and melted at 1200° C. for 4 h.

(3) Moulding

The melted product was moulded in a mold preheated to 780° C.

(4) Annealing

The moulded product was kept at 650° C. for 1.5 h and cooled to room temperature at a rate of 1.5° C./min to produce the glass wasteform of the radioactive waste (i.e., the glass wasteform of the simulated radioactive waste).

### EXAMPLE 20

A method for preparing a glass wasteform of radioactive waste was provided herein, which was specifically described as follows.

(1) Grinding and Mixing

94% by weight of the matrix prepared by the above method and 6% by weight of simulated radioactive waste were ground and mixed to produce a mixture, where the simulated radioactive waste was MoO₃ or Nd₂O₃, and the grinding was performed by a ball mill, and the mixture had a particle size less than 200 mesh.

(2) Melting

The mixture was heated and melted at 1160° C. for 3.5 h.

(3) Moulding

The melted product was moulded in a mold preheated to 760° C.

(4) Annealing

The moulded product was kept at 630° C. for 1.2 h and cooled to room temperature at a rate of 1.2° C./min to produce the glass wasteform of the radioactive waste (i.e., the glass wasteform of the simulated radioactive waste).

### EXAMPLE 21

A method for preparing a glass wasteform of radioactive waste was provided herein, which was specifically described as follows.

(1) Grinding and Mixing

98% by weight of the matrix prepared by the above method and 2% by weight of simulated radioactive waste were ground and mixed to produce a mixture, where the simulated radioactive waste was MoO₃ or Nd₂O₃, and the grinding was performed by a ball mill, and the mixture had a particle size less than 200 mesh.

(2) Melting

The mixture was heated and melted at 1230° C. for 3.8 h.

(3) Moulding

The melted product was moulded in a mold preheated to 830° C.

(4) Annealing

The moulded product was kept at 680° C. for 1.7 h and cooled to room temperature at a rate of 1.8° C./min to produce the glass wasteform of the radioactive waste (i.e., the glass wasteform of the simulated radioactive waste).

### EXAMPLE 22

A glass wasteform of radioactive waste was prepared herein basically according to the process in any one of Examples 17-21 except for step (1). Specifically, in step (1), 95% by weight of the matrix prepared by the above method and 5% by weight of simulated radioactive waste were mixed, and the simulated radioactive waste was MoO₃.

In Examples 17-22, the matrix for vitrifying radioactive waste used in step (1) included 45%-65% by weight of SiO₂, 9%-18% by weight of Al₂O₃, 4%-12% by weight of CaO, 3%-10% by weight of MgO, 6%-16% by weight of Fe₂O₃+FeO, 2%-9% by weight of Na₂O+K₂O and 1%-5% by weight of TiO₂, where the matrix further included 1%-5% by weight of at least five compounds selected from the group consisting of MnO, P₂O₅, SO₃, BaO, SrO, ZrO₂, CuO, ZnO, Nb₂O₅, Rb₂O and Y₂O₃. The matrix used in any one of Examples 17-22 may have the same composition as that in any one of Examples 5-14.

In Examples 17-22, the matrix for vitrifying radioactive waste used in step (1) included 49.70% by weight of SiO₂, 14.83% by weight of Al₂O₃, 8.76% by weight of CaO, 4.27% by weight of MgO, 10.52% by weight of Fe₂O₃+FeO, 4.78% by weight of Na₂O, 1.99% by weight of K₂O and 3.16% by weight of TiO₂, where the matrix further included 1.99% by weight of at least five compounds selected from the group consisting of MnO, P₂O₅, SO₃, BaO, SrO, ZrO₂, CuO, ZnO, Nb₂O₅, Rb₂O and Y₂O₃.

In Examples 17-22, the matrix for vitrifying radioactive waste used in step (1) included 47.73% by weight of SiO₂, 14.22% by weight of Al₂O₃, 9.29% by weight of CaO, 4.81% by weight of MgO, 13.01% by weight of Fe₂O₃+FeO, 2.19% by weight of Na₂O, 1.48% by weight of K₂O and 3.37% by weight of TiO₂, where the matrix included 3.90% by weight of at least five compounds selected from the group consisting of MnO, P₂O₅, SO₃, BaO, SrO, ZrO₂, CuO, ZnO, Nb₂O₅, Rb₂O and Y₂O₃.

The grinding in step (1) of any one of Examples 17-22 was crushing by a jaw crusher and then milling by a ball mill. The ground mixture had a particle size less than 200 mesh.

The raw materials used herein were all commercially available. Unless otherwise specified, the percentages mentioned above referred to mass (weight) or those known to those skilled in the art, and one part by mass (weight) corresponded to one gram or one kilogram.

In the above embodiments, any value in the range of parameters such as temperature, time, speed and the amount of respective components was applicable.

Some technical solutions which had been recited in the prior art were not further specified herein.

The invention is not limited to the above embodiments, and the disclosure of the invention is realizable and has corresponding good effect.

What is claimed is:

1. A method for preparing a matrix for vitrification of radioactive waste, comprising:
(1) grinding a natural magmatic rock;
(2) melting the ground natural magmatic rock at 1450-1500° C. for 3-4.5 h;
(3) moulding the melted product in a mold preheated to 700-850° C.; and
(4) keeping the moulded product at 600-700° C. for 1-2 h followed by cooling to room temperature at a rate of 1-2° C./min to prepare the matrix for the vitrification of the radioactive waste.

2. The method of claim 1, wherein the matrix obtained in step (4) comprises 45%-65% by weight of SiO₂, 9%-18% by weight of Al₂O₃, 4%-12% by weight of CaO, 3%-10% by weight of MgO, 6%-16% by weight of Fe₂O₃+FeO, 2%-9% by weight of Na₂O+K₂O and 1%-5% by weight of TiO₂.

3. The method of claim 2, wherein the matrix obtained in step (4) comprises 49.70% by weight of SiO₂, 14.83% by weight of Al₂O₃, 8.76% by weight of CaO, 4.27% by weight of MgO, 10.52% by weight of Fe₂O₃+FeO, 4.78% by weight of Na₂O, 1.99% by weight of K₂O and 3.16% by weight of TiO₂.

4. The method of claim 2, wherein the matrix obtained in step (4) comprises 47.73% by weight of SiO₂, 14.22% by weight of Al₂O₃, 9.29% by weight of CaO, 4.81% by weight of MgO, 13.01% by weight of Fe₂O₃+FeO, 2.19% by weight of Na₂O, 1.48% by weight of K₂O and 3.37% by weight of TiO₂.

5. A method for preparing a glass wasteform of radioactive waste, comprising:
(1) grinding and mixing 93%-99% by weight of the matrix of claim 1 with 1%-7% by weight of simulated radioactive waste to produce a mixture;
wherein the simulated radioactive waste is MoO₃ or Nd₂O₃;
(2) melting the mixture at 1100-1300° C. for 3-4.5 h;
(3) moulding the melted product in a mold preheated to 700-850° C.; and
(4) keeping the moulded product at 600-700° C. for 1-2 h followed by cooling to room temperature at a rate of 1-2° C./min to prepare the glass wasteform of radioactive waste.

6. The method of claim 5, wherein the grinding in step (1) is crushing by a jaw crusher and then milling by a ball mill.

7. The method of claim 5, wherein in step (1), 93%-95% by weight of the matrix and 1%-5% by weight of the simulated radioactive waste are mixed; and the simulated radioactive waste is MoO₃.

8. The method of claim 5, wherein in step (1), the matrix comprises 45%-65% by weight of SiO₂, 9%-18% by weight of Al₂O₃, 4%-12% by weight of CaO, 3%-10% by weight of MgO, 6%-16% by weight of Fe₂O₃+FeO, 2%-9% by weight of Na₂O+K₂O and 1%-5% by weight of TiO₂.

9. The method of claim 6, wherein in step (1), the matrix comprises 45%-65% by weight of SiO₂, 9%-18% by weight of Al₂O₃, 4%-12% by weight of CaO, 3%-10% by weight of MgO, 6%-16% by weight of Fe₂O₃+FeO, 2%-9% by weight of Na₂O+K₂O and 1%-5% by weight of TiO₂.

10. The method of claim 7, wherein in step (1), the matrix comprises 45%-65% by weight of SiO₂, 9%-18% by weight of Al₂O₃, 4%-12% by weight of CaO, 3%-10% by weight of MgO, 6%-16% by weight of Fe₂O₃+FeO, 2%-9% by weight of Na₂O+K₂O and 1%-5% by weight of TiO₂.

11. The method of claim 5, wherein in step (1), the matrix comprises 49.70% by weight of SiO₂, 14.83% by weight of Al₂O₃, 8.76% by weight of CaO, 4.27% by weight of MgO, 10.52% by weight of Fe₂O₃+FeO, 4.78% by weight of Na₂O, 1.99% by weight of K₂O and 3.16% by weight of TiO₂.

12. The method of claim 6, wherein in step (1), the matrix comprises 49.70% by weight of SiO₂, 14.83% by weight of Al₂O₃, 8.76% by weight of CaO, 4.27% by weight of MgO, 10.52% by weight of Fe₂O₃+FeO, 4.78% by weight of Na₂O, 1.99% by weight of K₂O and 3.16% by weight of TiO₂.

13. The method of claim 7, wherein in step (1), the matrix comprises49.70% by weight of SiO₂, 14.83% by weight of Al₂O₃, 8.76% by weight of CaO, 4.27% by weight of MgO, 10.52% by weight of Fe₂O₃+FeO, 4.78% by weight of Na₂O, 1.99% by weight of K₂O and 3.16% by weight of TiO₂ and 1.99%.

14. The method of claim 5, wherein in step (1), the matrix comprises 47.73% by weight of SiO₂, 14.22% by weight of Al₂O₃, 9.29% by weight of CaO, 4.81% by weight of MgO, 13.01% by weight of Fe₂O₃+FeO, 2.19% by weight of Na₂O, 1.48% by weight of K₂O and 3.37% by weight of TiO₂ and 3.90%.

15. The method of claim 6, wherein in step (1), the matrix comprises 47.73% by weight of SiO₂, 14.22% by weight of Al₂O₃, 9.29% by weight of CaO, 4.81% by weight of MgO, 13.01% by weight of Fe₂O₃+FeO, 2.19% by weight of Na₂O, 1.48% by weight of K₂O and 3.37% by weight of TiO₂.

16. The method of claim 7, wherein in step (1), the matrix comprises 47.73% by weight of SiO₂, 14.22% by weight of Al₂O₃, 9.29% by weight of CaO, 4.81% by weight of MgO, 13.01% by weight of Fe₂O₃+FeO, 2.19% by weight of Na₂O, 1.48% by weight of K₂O and 3.37% by weight of TiO₂.
